(19) United States
(12) Patent Application Publication
(10) Pub. No.: US 2003/0058740 A1
(43) Pub. Date: Mar. 27, 2003

(54) Pest deterrent device utilizing instinctive reactions

(76) Inventor: Danny Charles Jincks, Annapolis, MO (US)

Correspondence Address: Danny Charles Jincks, Walnut Creek Enterprises, P.O. Box 70, Annapolis, MO, 63620, US

(21) Appl. No.: 09/779,976

(22) Filed: Feb. 9, 2001

Related U.S. Application Data
(60) Provisional application No. 60/181,452, filed on Feb. 10, 2000.

(51) Int. Cl. H04B 1/02

(52) U.S. Cl. 367/139

(57) ABSTRACT

An apparatus for discouraging an undesired animal from entering, remaining upon or returning to property. The apparatus first comprises a timer for selectively activating a sound generator at a specified interval for a specified duration. The activated sound generating device triggers an innate fear in a targeted animal by projecting one or more sounds that suggest the presence of a predator of the targeted animal, thereby causing the animal to flee or avoid that particular area. Furthermore, the undesired encroachment of an animal may be sensed by proximity sensors to immediately activate the sound generator or trigger the timing device. Further, the invention comprises a visual generating device producing a visual stimulus concurrent with the specified duration of the generated sound.

### BACKGROUND OF THE INVENTION

This invention relates generally to a device for deterring and/or repelling animals from property and areas where their activities conflict with human interests, and so have become pests. The invention particularly relates to a device that by its action causes the pest animal to avoid the area either immediately or eventually; and to impress upon the animal that the area is undesirable, resulting in a change in its activities and a reduced presence in the area of interest. It accomplishes this action with sound or visual stimulus which utilizes the animals instinctive knowledge as a channel of communication.

Controlling damaging activity of pest animals is a field of invention that undoubtedly pre-dates written history. The typical solutions consist of various means of destroying, annoying and physically excluding. They do not communicate a meaningful message to the animals, so the survivors usually continue with their undesirable activities to whatever extent they may. This invention differs with these prior attempts in that its primary intent and action is to communicate a message that is genuinely meaningful to the pest animal. By conveying an effective meaningful message through an animal's instincts, the animal itself makes the decision that results in it avoiding a valued area, which eliminates its status as a pest. Where prior inventions of animal control need to scream loud and glare anger, this invention need only produce a whisper or wink to achieve far greater results because the animal understands the message. This represents considerable improvement by not damaging the animal or environment, by utilizing simple, inexpensive means to protect large areas, and by typically achieving long term effectiveness equal or better than ugly and awkward fenced enclosures.

The principal of this invention is to utilize instincts of animals to cause a reaction that results in deterring the pest animals from an area of protection. Instincts are a vitally important universal feature in all animals. It is inborn knowledge requiring no learning. As example of a direct fear evoking reaction, a cougar, a predator of deer, produces characteristic sounds such as a hiss or scream. It has been discovered, through experimental trials, that a cougar's hiss and scream proved to be instinctively known to deer. When exposed to these sounds, a deer will typically exit the vicinity of the sound source immediately and without hesitation; particularly at night when visual identification is difficult. Since deer that more than likely have not experienced a cougar reacted in such a manner, these sounds were believed instinctively known to them. Similar test results were observed with other animal species; typically mammals with nocturnal habits such as skunk, raccoon, coyote, opossum and beaver. Numerous tests in a diversity of locations throughout the United States achieved similar results, which confirmed that a cougar's hiss and scream sounds are an instinctively recognized channel of communication to a number of nocturnal mammals that are notorious as pests to human interests. By presenting these sounds in an advantageous manner, so as to create an illusion to the animals that a cougar is lurking nearby, the pest animals soon associate a deadly risk with the location where the sounds are heard regularly, and avoid that area as a survival reaction. The animal assess the risk, and it makes a decision based on an instinct, from a message that has a genuine meaning to it, with the message of meaning being produced in the advantageous manner by this invention.

While some embodiments of this invention may superficially appear similar to prior electronic sound producing animal repellant devices, its mode of operation and method of effectiveness is new and different in that it specifically utilizes stimulus to effect a reaction through an animal's instincts. For comparative examples see, U.S. Pat. No. 4,658,386 to Morris (incorporated herein by reference) entitled An Ultrasonic Sound Wave Generating Device for Repelling Animals. Which is adapted for use with refuse and garbage containers to discourage entry therein by foraging animals. And U.S. Pat. No. 5,602,523 to Turchloe, et al. (incorporated herein by reference) discloses an animal repelling system especially for deer which generates a square wave signal output in the ultrasonic frequency range, which has a piezo-electric driver utilizing a horn type device that produces harmonic distortion so that at any given time the fundamental frequency and harmonic distortion is present in the audio output, and the system is capable of frequency switching to at least 10 different frequencies.

While these “ultrasonic” repellants seem to possess mysterious and magical capabilities, they are in reality no more than producers of crude pointless loud noises. The sounds produced by these devices are not much different than the sounds coming from a police or ambulance siren, other than the fact that the frequencies are higher. Imagine trying to live and function near the constant output of a very loud police siren, and you get a good idea how these “ultrasonic” noisemakers achieve their effect on the animals that can hear them. Effectiveness of these “ultrasonic” noisemakers is by virtue of causing an unpleasant sensation or interfering with the animals ability to hear clearly. It is an admirable achievement that their annoying sound output is in a frequency range outside of our perception, however they effect no meaningful message to the animal and since their effectiveness is linked to the intensity of the sound, any effectiveness is of a very limited range.

As further example see, U.S. Pat. No. 4,965,552 to Price et al. (incorporated herein by reference) which discloses an animal repellant apparatus that includes a microphone for detecting environmental sound, a detection circuit for detecting the presence of a particular species of animal in the vicinity of the repellant apparatus, a timing and activation circuit, and a plurality of frightening devices. While the detection circuit appears to be a clever innovation, it has very limited usefulness beyond animals such as species of black birds commonly known as Grackle, which reliably produce a specific noise while they go about foraging activities. Most animals do not reliably produce any useable sound while going about their activities. While this invention makes mention of “frightening devices,” no meaningful disclosure is made concerning what they would actually consist of and it can be assessed that the inventors have no unique invention to fulfill this description, and further there is no mention of these undefined “frightening devices” creating any instinctive recognition or related reaction. A mention is made about a “loud blast,” and later a “siren,” which are typical startling and unpleasant stimulus, containing no meaningful instinctive message. In essence this invention is only a detection and triggering device, or a proximity sensing device, suited for an extremely limited range of pest animal species. It does not actually include any repellant stimulus as its title appears to state. The triggering output demonstrates complexity, which infers trying to overcome difficulties which are characteristically inherent to non-instinctive repellant devices. This type of complexity of presentation becomes a necessity for any hope of long term success from non-instinctive repellents. It is an attempt to prevent “animals from becoming accustomed to the repellant apparatus.” Which is a fairly clear indication that they are referring to a stimulus with no meaningful instinctive connection. Their type of complexity is expensive and is not a necessity for a deterrent/repellant device based on instinctive recognition and reaction to the output stimulus.

Use of this invention establishes localities that pest animals will avoid, by their own decision, without doing harm to the animals and without using physical barriers or introducing environmental contamination. It has the novel approach of directly utilizing an animals own instincts as a means of communicating with the animal. It does so by generating motivating illusions which the animal believes to be real due to is inborn knowledge.

This invention's ability to control pest animals is substantially different than prior repellant devices. It works by discouragement, or deterrent effect, rather than being physically unpleasant, difficult or painful or interfering with their senses. Repellants that startle, such as with a sudden loud noise, do use superficial universal reaction, but without any communicated meaning. Repetition of meaningless stimulus, that was initially startling, soon becomes recognized as harmless and the animal pays little, if any, further heed to it. If the stimulus has an inborn meaning to the animal, it remains meaningful without respect to repetition, unless the animal becomes conditioned otherwise by a stronger conflicting learning experience.

An instinct is not merely a superficial reaction, but is inborn knowledge that guide critical activities, and if utilized properly, it can produce a consistent reaction from almost all members of an animal species. One method to test a reaction as being an instinct, is to expose many isolated individuals of the animals species to the stimulus, and if the reaction is similar in a large majority of the individuals, it is obviously an inborn characteristic, or instinct, of that species. There is clear evidence that instincts cannot change for a great many generations, if at all. If they could change quickly, isolated groups of a given species would develop noticeably different inborn reactions, and this is not the case in nature. Therefore, because the instinctive reactions of a particular species to a particular stimulus is universal, it provides a reliable channel of communication.

To be meaningful to an animal, the instinctive stimulus concerns survival. The most reactive would be negative stimulus such as predator awareness, or positive stimulus such as reproduction. A perceived predatory presence would strongly discourage the perceiving animals presence. A perceived reproduction opportunity would strongly attract the animal toward the the source of the perceived opportunity. Other stimulus relating to food, water, shelter, or environmental preferences are weaker.

Typically the source of undesirable activity from a pest animal involves one of the weaker inborn stimulus, and a stronger stimulus is used to counter it. For example, avoiding death or injury takes priority over a meal. This invention implements stronger inborn reactions which have priority over weaker ones, or over activities not of an inborn nature.

Sound perception and sight, typically offer the greatest coverage potential for implementing instinct based reaction. Light and sound can be radiated in a relatively homogenous manner effecting large areas. Sound is much less obstructed by physical barriers. A sound based illusion generally requires simpler less expensive means than a equally effective visual illusion. Sight based deterrents are useful in situations where sound output is not practical, or for animal species that favor sight and have a low reactivity to sound. Taste, smell, and touch are typically weaker, lower priority, short range, and secondary senses versus sight and hearing.

Perception of sound and light by animals may be substantially different than what humans can perceive. Many animals perceive and articulate complex sound patterns at higher and lower frequencies. Some perceive vibrations without the aid of ear like organs. Sound, as it pertains to animals and this invention; are physical vibrations of a solid, liquid or gas at any frequency, perceivable by the animal. Sight or visual perception, as it pertains to animals and this invention, is any useful perception by the animal from any direct or reflected light energy, at any wavelength, intensity, or pattern that it can utilize.

For many embodiments, sound is the primarily source of illusion. For other embodiments, a visual means may also be used to enhance and support the sound means. For some embodiments, an instinctively recognized visual means is used instead of sound, using a similar presentation means as for some of the sound based embodiments.

To generate a convincing illusion the instinctively recognized sound or visual means must be presented using means that support and enhance the illusion. Any prolonged exposure, or frequent short exposure, to an artificially produced sound or sight would give the animal opportunity to study it, and could result in a conflicting learning experience which would expose and ruin the illusion. Timing of exposure is critically important to present the stimulus for affect and also to maintain a believable illusion on a permanent basis.

Instinct based stimulus require no learning or study, so recognition is very rapid. They do not require intensity to have a strong effect. A soft sound, or blurred or incomplete visual image, can have excellent effectiveness because the animal will complete its inborn mental image. Since instinctive stimulus do not require intensity to effect reaction, affective range often extends to the limits that the animal can perceive it, which can be very large compared to repellents based on non-instinctive unpleasant sensations—which are intensity dependant. The presentation needs to be short exposure at a believable intensity, of instinctively recognized stimulus. Ideal exposure varies with respect to stimulus and species, but will be one minute or less in duration.

The second timing element is when the stimulus output will be executed. A proximity sensing means can be used to initiate on output cycle every time an animal is detected. This can be useful for protecting smaller areas from larger animals, but may not be practical for small animals or large areas of protection.

Timed execution is a much more universal means. The intervals between output executions need to be long enough to create an element of shock or surprise, but also short enough to avoid intolerable damages by the pest animal. Surprise increases the impression of danger and also reduces the animals ability to clearly perceive and remember details about the deterrent's stimulus, which helps avoid conflicting learning experience. The ideal interval varies with respect to stimulus and species, being between 1 to 60 minutes.

A further optionally desirable limiter is to only output reactive stimulus during a certain portion of each day. If the animal is nocturnal, darkness helps to protect the illusion because animals will react to sound without waiting to identify a visible source, and any visual stimulus utilized need not be highly detailed. Night-only use also does not affect or annoy daytime active animals. Stimulus can also change at night/day transitions so that one stimulus affects one species during daylight and a second stimulus affects a different at night. When an animal experiences intense instinctive shock, a few times in the same locality, it decides to avoid this locality on a long term or even permanent basis. Even if the animal is exposed only at night, it will avoid the area during daylight hours as well.

Identifying and proving that a sound or visual stimulus as both instinctive and useful, involves study and experimentation. Stimulus can be negative to cause fear and direct discouragement, or positive to attract.

Attractions might come from sounds produced by the animal and also sounds of prey if it is predatory. Some uses for attractants would include; attracting an antagonist of the pest, or attraction of pests out of a large area into the vicinity of a short range pest control solution.

Negative instinctive stimulus is often obscure and requires extra research about the pest animal. If the animal lives in; herds, flocks, hives, etc.; there are probably instinctive signals used to warn others when danger is near. Stimulus mimicking an animal that is harmful toward the pest may yield an instinctive reaction. The most powerful negative, fear evoking, stimulus has been that which is related to a predator of the pest animal.

Field testing in a wild setting or typical application setting, in at least a few different locations, is required to verify that a stimulus is both effective and likely instinctively recognized. Interpretation of a field testing results is not always straight forward. For example, a hiss sound, as produced by a cougar, was the original instinctive deterrent sound discovered and used to deter white-tailed deer at night. Deer tracks indicated fast reaction and immediate exits, but activity continued in the area for a couple of weeks, with intermediate periods of absence—then it ceased. Each animal had to be exposed two or more times in the same location to associate the danger with that specific location.

The same night-only hiss sound did not initially seem to produce any effect on skunk, but a month after testing started, there were no skunk remaining in the testing area. When exposed, they might look around or stay close to cover, but they continued with their activities. However, they quit returning to an abundant source of food, after several visits with intermediate periods of absence. Skunk must deal with predators by direct confrontation rather than immediately running from them. Since there was no actual confrontation, the illusion was not immediately convincing. Their abandonment decision was made after repeated foraging visits which were nerve wrecking rather than terrifying. Which took longer and required more visits, than was typical for deer.

This exemplifies the difference between deterrent effect and repellent effect. The skunk were discouraged, or deterred, but not immediately repelled. The deer were both immediately repelled, and also deterred on a long term basis. Properly utilized instinctive reactions typically yield long term deterrent effect, which is their intent, but immediate repellent effect is not always present. Non-instinctive repellents typically cannot provide long term deterrent effect since they cannot effect a clear decision about the situation to the targeted pests. Instincts provide a clear channel of communication, whereas an dissociated unpleasant experience provides none and only yields confusion to the animal in many cases.

There is a need for an effective repellant device that discourages the undesired presence upon property of an animal without substantial cost or risk of injury to the animal. There is also a need for an effective repellant device which utilizes the animals innate fears to discourage its presence, rather than chemicals or other substances which may be harmful to desired animals, humans and/or the environment.

### SUMMARY OF THE INVENTION

The invention meets the above needs and overcomes the deficiencies of the prior art by providing an apparatus that repels an animal by relying on its instinctive reaction to a perceived threat. The apparatus resolves the problems associated with repelling undesired animals from property by reducing cost and decreasing the risk of injury to the target animal, other animals, persons and the environment.

Briefly therefore, the invention sets forth an improved apparatus for discouraging an undesired animal from entering, remaining upon or returning to property. The apparatus first comprises a timer for selectively activating a sound generator at a specified interval for a specified duration. The activated sound generating device triggers an innate fear in a targeted animal by projecting one or more sounds instinctively recognized by animals that suggest the presence of danger to the targeted animal, thereby causing the animal to flee or avoid that particular area.

The invention further sets forth an improved apparatus for discouraging an undesired animal from entering, remaining upon or returning to property. The apparatus first comprises a timer for selectively activating a sound generator at a specified interval for a specified duration. The activated sound generating device triggers an innate fear in a targeted animal by projecting one or more sounds instinctively recognized by animals that suggest the presence of danger to the targeted animal, thereby causing the animal to flee or avoid that particular area. The apparatus further comprises a terminal connection or port for receiving input, when an animal is sensed by proximity sensing means, to immediately activate the sound generator or trigger the timing device.

The invention further sets forth an improved apparatus for discouraging an undesired animal from entering, remaining upon or returning to property. The apparatus first comprises a timer for selectively activating a sound generator at a specified interval for a specified duration. The activated sound generating device triggers an innate fear in a targeted animal by projecting one or more sounds instinctively recognized by animals that suggest the presence of danger to the targeted animal, thereby causing the animal to flee or avoid that particular area. Further, the device comprises a visual generating device producing a visual stimulus instead of or concurrent with the specified duration of the generated instinctively recognized sound.

The invention further sets forth an improved apparatus for discouraging an undesired animal from entering, remaining upon or returning to property. The apparatus first comprises a sound generating device that triggers an innate fear in a targeted animal by projecting one or more sounds instinctively recognized by animals that suggest the presence of danger to the targeted animal, thereby causing the animal to flee or avoid that particular area. The apparatus further comprises a terminal connection or port for receiving input, when an animal is sensed by proximity sensing means, to immediately activate the sound generating device.

The invention further sets forth an improved apparatus for discouraging an undesired animal from entering, remaining upon or returning to property. The apparatus comprises a visual generator which provides an instinctively recognized visual stimulus to the animal, such as to suggest the presence of danger. The apparatus further comprises a timer for selectively activating the visual generator at repeated periods of time and/or a duration of time, as defined by operator input.

Alternatively the invention may comprise various other methods and systems. Other objects and advantages will become apparent to those skilled in the art from the detailed description herein read in conjunction with the drawings attached with

### BRIEF DESCRIPTION OF THE DRAWINGS

FIG. 1A depicts a side cross sectional view of the animal repellant apparatus of the present invention.

FIG. 1B depicts a frontal view of the animal repellant apparatus of the present invention

FIG. 2 illustrates a functional block diagram of an embodiment of the invention that generates sound via a sound synthesizer.

FIG. 3 shows a circuit diagram which corresponds with the embodiment of the invention as shown by the functional block diagram illustrated in FIG. 2.

FIG. 4 illustrates a functional block diagram of an embodiment of the invention that generates sound via an audio player and optional sound recording.

FIG. 5 shows a circuit diagram which corresponds with the embodiment of the invention as shown by the functional block diagram illustrated in FIG. 4.

FIG. 6 illustrates a typical 2 watt output slave amplifier.

FIG. 7 describes a trip line connected to a switch to perform a make/break switching means.

FIG. 8 illustrates an animal walking through the light casting a “NightShadow” to trigger a sounding.

FIG. 9 depicts the optional secondary switch which will simultaneously turn on a secondary device whenever the sound output is activated.

FIGS. 10A and 10B show two circuits for accomplishing automatic day/night switching.

FIGS. 11A and 11B show a circuit for randomly selecting 1 of 4 available sounds and corresponding chart of positive voltage or ground logic to access addresses.

FIGS. 12A and 12B show two photovoltic battery charging circuits.

FIGS. 13A, 13B, 13C, 13D and 13E show a visual deterrent.

Corresponding reference characters indicate corresponding parts throughout the drawings.

### DETAILED DESCRIPTION

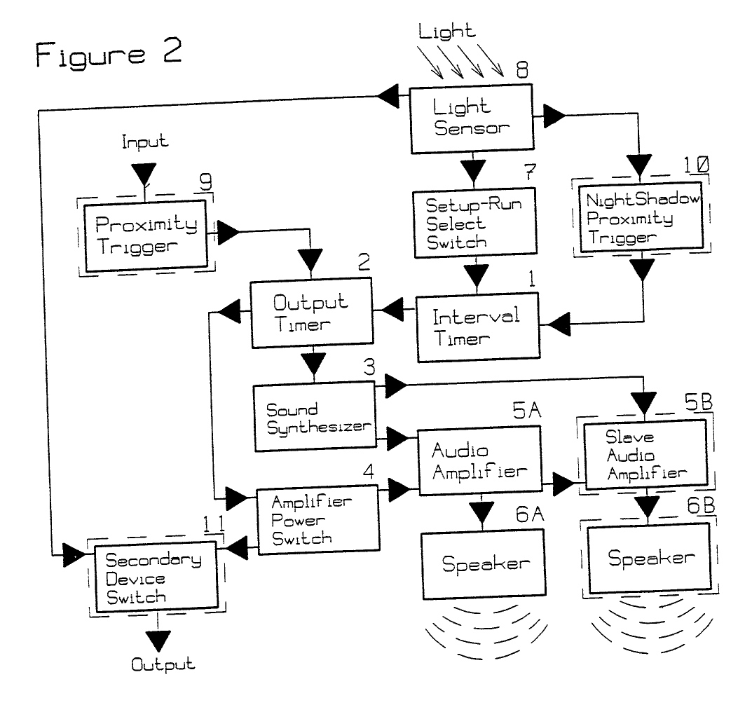

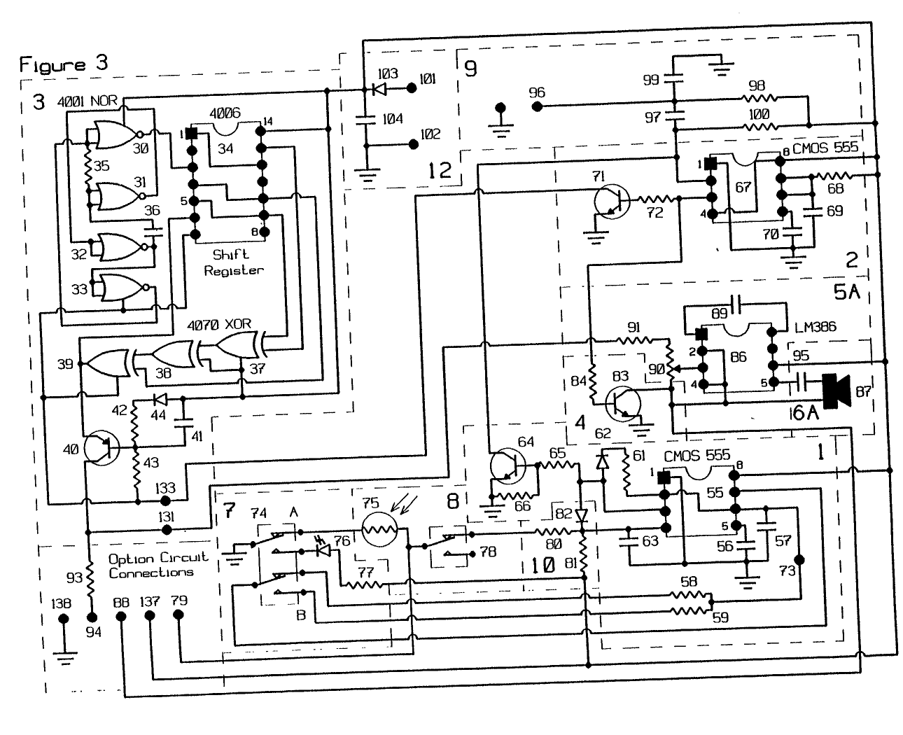

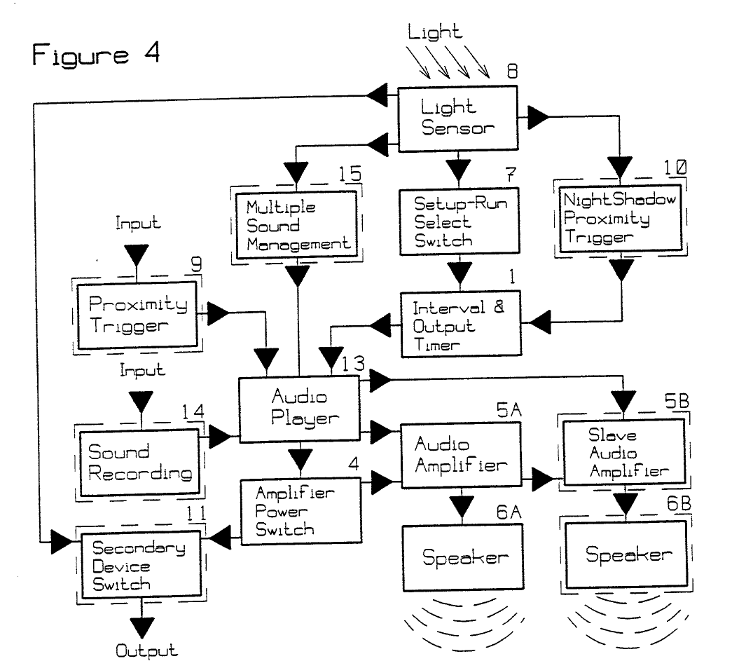

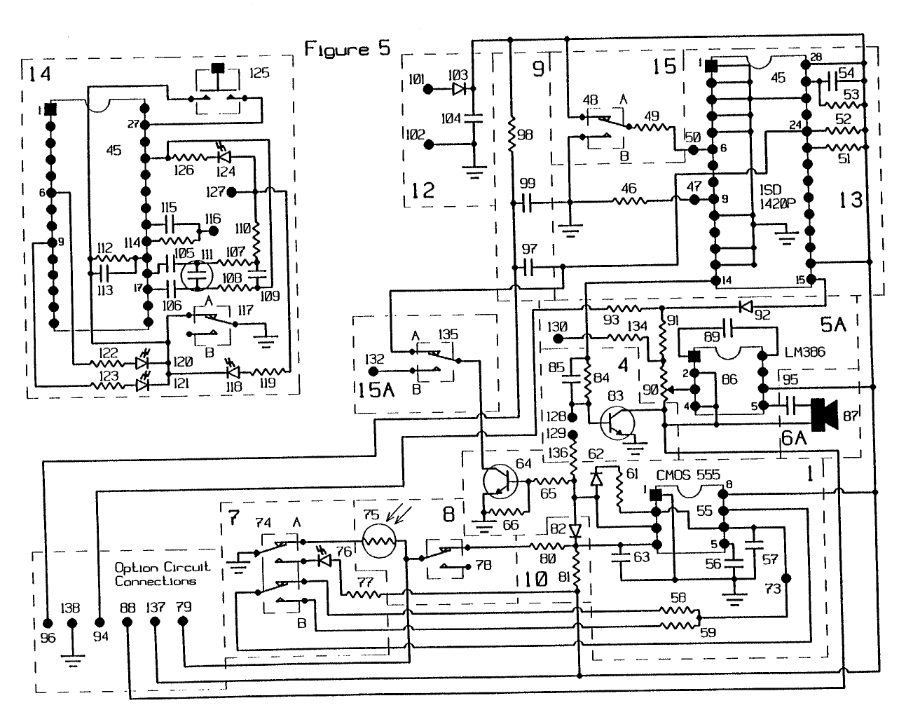

For the purpose of promoting the understanding of the principles of the invention, references will now be made to the embodiment illustrated in the drawings and specific language used to describe the same. The circuitry embodiment contained herein are not intended to limit the scope of the invention to these specific means. The embodiment is depicted in both block diagrams and circuit diagrams. The block diagrams depict functions which are important to the embodiment. The circuitry represents employments of the block function. The numbered blocks shown in the functional diagrams illustrated in FIG. 2 and FIG. 4, correspond with numbered sections of circuit diagrams illustrated in FIG. 3 and FIG. 5. Circuit diagram sections are outlined by dashed lines. For clarity, integrated circuits are depicted correctly for their DIP packages, as to pin locations, as viewed from the top. A square indicates pin 1.

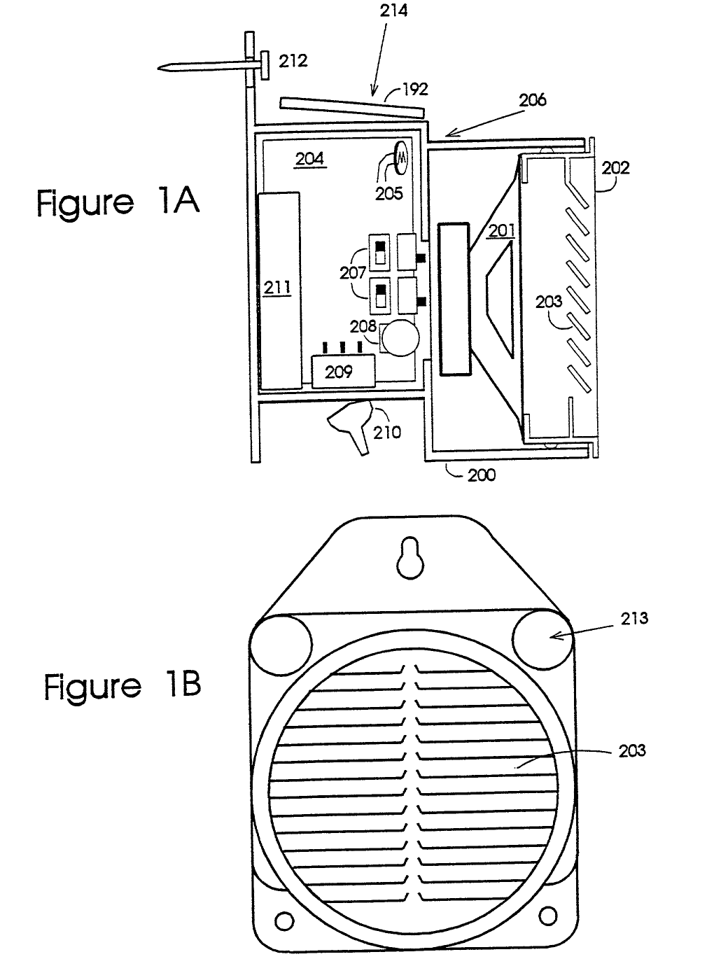

FIGS. 1A and 1B depict the animal repellant apparatus of the present invention comprises speaker 201 attached to a louvered grill 203 comprising front cover assembly 202 which press fits into the main housing 200. A circuit board 204 is attached to the inside side of the rear of the housing. A Photo resistor light sensor 205 is situated and aimed out a translucent area 213 of the housing where light 206 can strike it entering from a forward direction as indicated. The switches 207 are mounted on the circuit board as is volume control 208. They are accessed by removing front cover assembly 202. Switch 209 is mounted to the housing and actuator 210 is on the exterior underside so as to protect it from rain and ice. The batteries 211 are held to the back of the housing. The housing can be mounted such that photovoltic panel 192 use sun light 214 to charge batteries 211.

FIG. 2 illustrates a functional block diagram of an embodiment of the invention that generates sound via a sound synthesizer. The sound generated by the synthesizer approximates a hiss often associated with a feline, member of the large cat family. A dashed block in FIG. 2 indicates an optional feature.

Referring to FIG. 2, an interval timer 1 provides a signal to an output timer 2 which activates the sound synthesizer 3. The output signal from the sound synthesizer 3, is amplified either by the audio amplifier 5a and optionally by the slave audio amplifier 5b, and transmitted to and emitted from speaker 6a or 6b. The amplifier power switch 4, turns the audio amplifier 5a and optionally the slave audio amplifier 5b on and off. A setup/run selection switch 7 determines how the interval timer 1 operates. The output signal from a light sensor 8, is used in conjunction with the setup/run selection switch 7 to determine when the interval timer 1 operates. The activation of an optional proximity sensor through input 9 provides an output signal directly to the output timer and immediately activates the sound synthesizer 3. The output signal from a light sensor 8, in conjunction with the activation of an optional “nightshadow” sensor 10, immediately activates the interval timer 1. Furthermore, an optional secondary switch 11 serves as a connection point for additional repelling devices.

In operation of the embodiment shown in FIG. 2, depending on the targeted species, the output timer 2 is set to allow the sound generator to produce an instinctively recognized sound for a duration of one minute or less, and the interval timer 1 provides an interval from one to 60 sixty minutes between the sounds instinctively recognized by animals. For example, if the targeted species is deer the output timer 2 is set to allow the sound generator to produce an instinctively recognized animal sound for a duration of approximately 5 to 10 seconds, and the interval timer 1 is set to provide an interval of approximately 6 minutes between the production of the sounds instinctively recognized by animals. When using the device of the invention, it is preferable that humans not be associated with it. For example, if a human is holding the device when it sounds, it could minimize or ruin the illusion because the animal being repelled may associate the sound with the human. Since a human may not be considered to be a deadly threat, the animal being repelled will not react instinctively to flee. On the other hand, to desensitize pets or livestock, do the opposite; that is, allow them to see a human holding the deterrent while it is sounding. The sound is then associated with the human and is remembered as harmless.

Referring now to FIG. 3, there is shown a circuit diagram which corresponds with the embodiment of the invention as shown by the functional block diagram illustrated in FIG. 2. The interval timer 1, integrated circuit 55 is a CMOS 555 type timer configured for adjustable continuous astable operation. Pin 1 is ground supply. Pin 8 is positive voltage supply. Capacitor 56 is recommended by some manufacturers for stability. There are two time based functions that can be produced by this section. First, a short ON state output. Second, a long OFF state interval. These on—off states repeat continuously while the timer is energized unless stopped by a low state applied to pin 55/4, which resets and stops operation until pin 55/4 returns to a high state. Capacitor 57 and resistors 58 or 59 determine the OFF interval time, which is typically four to twelve minutes for 57 and 58; and less than one minute for 57 and 59; for many embodiments. The longer time is for animal deterrent use and the shorter time is to aid in initially setting up the device and adjusting the output volume. Switch 74 selects which resistor connects between pins 6 and 7, which is the discharge path for capacitor 57. The ON output time is determined by resistor 61 and diode 62. Typical ON time is 5-20 seconds, to play the instinctively responsive deterrent sound(s). Capacitor 63 creates a delay for changes in state to 55/4 reset, to prevent undesirable false or repeat resets. Pin 3 is the timer output which is ground during the long OFF intervals and positive voltage during the short ON output. Pin 55/3 output turns on transistor 64 which inverts the output as a ground signal or else is a current sink for the synthesizer circuit, depending on the embodiment. Resistor 65 limits current and resistor 66 is used to prevent false ON states for low current signals.

The output timer 2, is used in an embodiment of the invention as a separate timer to independently provide the ON time that plays the actual reactive sound(s). When output timer 2 is used, interval timer 1 only acts as the OFF interval timer. CMOS 555 type timer 67 is configured as a monostable timer. Whenever ground is applied to pin 67/2, even for a brief pulse, the output at pin 67/3 goes high for a period determined by the values of resistor 68 and capacitor 69, which is typically 5-20 seconds for many embodiments. Pins 1, 4, 5, and 8 are as described in section 3, with capacitor 70 required for stability. The ON state positive voltage at pin 67/3 is inverted and becomes a current sink through transistor 71 to energize section 1 synthesizer for the preferred embodiment, but can be used to energize secondary devices as well. Resistor 72 limits current to transistor 71.

The sound synthesizer 3, provides a hiss sound that is synthetically produced by a white noise source that gradually builds in volume from off to full over a few seconds, holds at full volume for a few seconds, and then ends abruptly. Three CMOS digital logic integrated circuits are interconnected and utilized to produce the white noise source. Reference characters 30, 31, 32, and 33 denote the 4-4001 NOR gates which provide clock pulses to the 4006 static shift register 34. Resistor 35 and capacitor 36 initiate pulses at a frequency range determined by their values, with 150 K and 470 pf being values in the preferred embodiment. The inputs and outputs of static shift register 34 are interconnected and then connected to 3-4070 exclusive OR gates 37, 38, and 39; finally being output at 39 and fed back into the static shift register. This creates a random set of frequencies at the output of XOR 39, which is used as the white noise source. This arrangement of CMOS digital logic integrated circuits has on occasion been seen published as a public domain white noise generator application example, and is not a circuit unique to this invention. A PNP transistor 40 controls the output volume of the white noise. As capacitor 41 initially charges, it causes a gradual increase in transistor base voltage when the circuit is first energized. Once capacitor 41 has fully charged, transistor 40 base voltage stabilizes at the voltage defined by resistors 42 and 43, which form a voltage divider, and transistor 40 achieves and remains at full volume output. When this circuit is turned off, capacitor 41 discharges into resistor 42, and the circuit is reset for the next cycle. Diode 44 prevents capacitor 41 from discharging until the circuit is turned off.

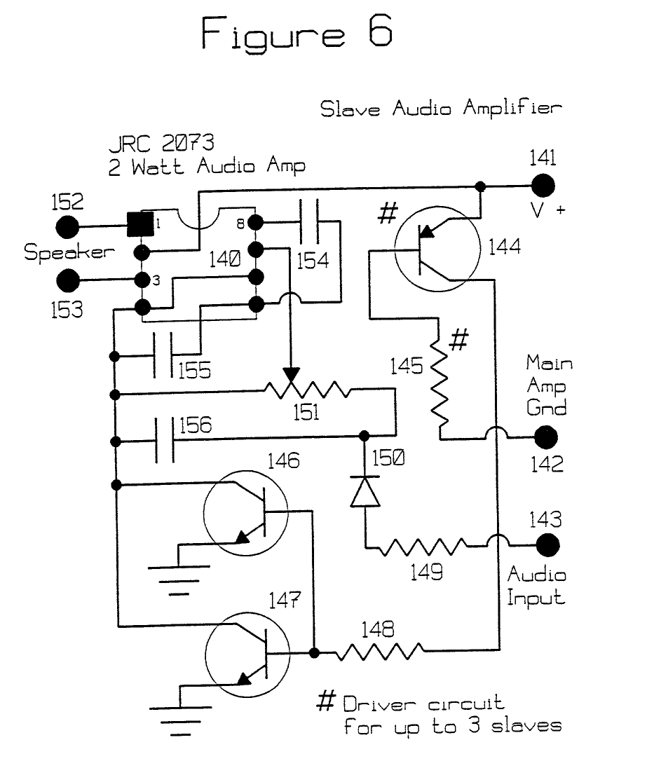

The audio amplifier 5A, integrated circuit 86, is a low output impedance LM386 type audio amplifier with ½ watt output into an 8 ohm impedance speaker. Capacitor 89 sets the gain and is connected between pins 1 and 8. Pins 2 and 4 connect to ground. Pin 6 is positive voltage supply. Pin 3 is the audio signal input with variable resistor 90 being the volume adjustment. Resistor 91 limits current and adjusts signal level. Diode 92 (FIG. 5) is required with ISD 1420 embodiments. Resistor 93 limits current and adjusts signal level at connection 94 for option circuits. Pin 5 is a capacitively coupled speaker driver output. Some embodiments alternatively use the higher output 2 watt JRC2073 amplifier, illustrated in FIG. 6.

The audio slave amplifier 5b, is utilized when higher sound levels are needed for noisy or larger areas. One or more additional audio amplifiers and paired speakers can be connected and employed. FIG. 6 illustrates a typical 2 watt output slave amplifier using a JRC2073 integrated circuit 140. Point 141 connects to 137 for positive supply voltage. Point 142 connects to point 88 to turn on the amplifier only when sounding occurs. Point 143 connects to point 94 which supplies the audio signal. Ground connects to point 138. When sounding occurs, point 142 goes to ground and driver transistor 144 turns on through current limiting resistor 145. Positive voltage from transistor 144 turns on transistors 146 and 147, through resistor 148. Transistors 146 and 147 are identical and supply the ground path for amplifier 140. Audio input from point 143 goes through current limiting resistor 149 and diode 150 to the volume controlling variable resistor 151 connected to the pin 7 audio input of amplifier 140. Pins 1 and 3 of IC 140 are speaker outputs 152 and 153 to drive a 4 ohm or higher impedance speaker at up to 2 watts. Capacitors 154, 155, and 156 are as recommended by the 140 amplifier IC manufacturer. Driver transistor 144 can also be utilized to turn on other amplifiers or devices.

To minimize power consumption, both audio amplifier 5A, and audio slave amplifier 5B are turned off during the intervals between sound output by an amplifier power switch 4. This conservation greatly increases battery life. Current sinking through transistor 83 acts as the off/on switch, turned on through current limiting resistor 84. The embodiment shown in FIG. 5 has capacitor 85 in parallel with resistor 84 to absorb voltage fluctuations. The current sink supplies a ground path for audio amplifier 86 and speaker 87 power needs. Connection 88 acts as the turn on for option circuits so that they may also shut down to maintain power efficiency. In yet another embodiment, a second transistor identical to transistor 83 is connected in parallel to 83 to handle the additional current demands, as illustrated with 146 and 147 in FIG. 6

Sounds are emitted through speakers 6A, 6B. The speakers have, but are not limited to, an impedance of 8 ohms or greater and are rated for 1 watt or greater for the LM386 amplifier embodiments, and an impedance range from 4 to 8 ohms, rated for 3 watt or greater for the JRC2073 amplifier embodiments. With the LM386, capacitor 95 is required.

The setup/run selection switch 7 in FIG. 2 and FIG. 4 and switch 74 in FIG. 3 and FIG. 5, is a double pole double throw. Switch 74, selects between normal deterrent operation and setup mode. In position B, it is in setup mode which disables any functions controlled by photo resistor 75, which are typically related to night-only operation; and also energizes Light Emitting Diode (LED) 76. Disabling of night-only mode is required to allow sounding the device during daytime. Current limiting resistor 77 is of a fairly high value, so that if the batteries are weak, LED 76 will dim or go out when the device sounds, due to pulling down battery voltage by the increased current loading. LED 76 has the dual function of warning that the device is in setup mode and helps indicate battery condition. Setup position B also sets play of sound at less than one minute intervals so that the deterrent user can conveniently study the area needing protection and determine if the volume is adjusted properly. Position A sets the device to normal operation, typically sounding only at night, at four to twelve minute intervals, for many embodiments.

The light sensor 8, is a photo resistor used to sense environmental light and automatically set operation modes. Sensor 75 is a Cadmium Sulfide (CdS) type or similar, that has high resistance in darkness and low resistance in bright lighting. Switch 78 is provided on some embodiments to disconnect the sensor so that sounding occurs both day and night. A closed circuit is used if switch 78 is not used. Option connection 79 is provided to share the function of the light sensor with optional circuits related to day-only or night-only modes of operation. The primary function of many embodiments is to affect the reset pin 55/4 of the timer to stop timer operation during daylight hours so that sounds are only produced at night. Resistor 80 limits current if other inputs are utilized.

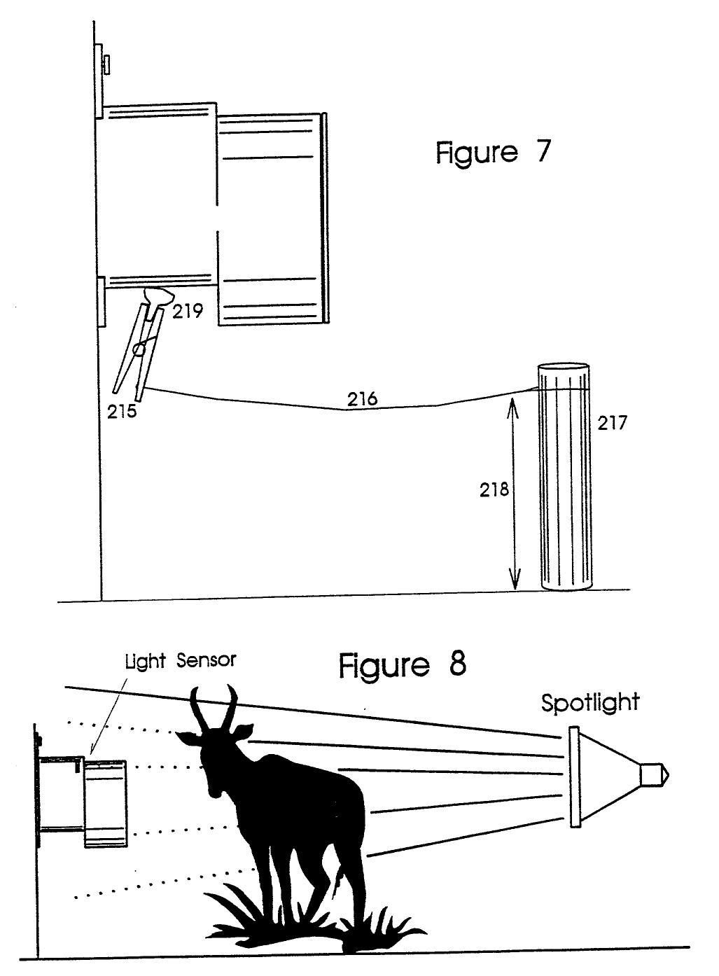

The optional proximity trigger 9 can utilize input to immediately activate the sound synthesizer when an animal is nearby and provides more effective localized protection. The proximity input gets top priority and can trigger a sounding anytime that the deterrent is turned on, even if timed output is muted during daylight for a night-only device. Connection point 96 is the trigger input and is activated by its connection to circuit ground. Any make/break switching means can be used to activate it. Depicted in FIG. 7 and described in detail below, a trip line connected to a switch can perform this function. Other means such as a pressure plate switch, motion detector, infrared detector or other means can be connected. The actual triggering signal is a ground pulse through capacitor 97, which isolates the triggering means connection so that a continuous ground connection to 96 will not interfere with other modes of operation. Resistor 98 and capacitor 99 generate the pulse signal, with resistor 100 being a pull up device for the 67/2 input. With the ISD 1420 embodiments, resistor 52 performs the pull up function.

The optional night shadow sensor 10, utilizes photo resistor 75 to detect a change in light condition. By shining a light at the sensor at night the timer goes into reset mode, and when the light is obstructed, even momentarily, the timer starts and a pulse can trigger an immediate sounding. FIG. 8 illustrates an animal walking through the light casting a “NightShadow” to trigger a sounding. This arrangement allows silent operation until an animal is actually present. When light strikes photo resistor 75, ground is conducted through resistor 80 to cause a reset of timer 55. Resistor 81 holds pin 55/4 high until photo resistor 75 conducts sufficiently to drop the voltage at pin 55/4 to a low state. Capacitor 63 provides a delay so that quick or slight fluctuations in light or battery voltage don't set up multiple reset cycling or false triggering. Diode 82 provides a positive voltage source that forces the reset pin 55/4 high for the duration of the timer output so that it cannot reset prematurely due to light striking the photo sensor again during sounding, and thus stopping play back before completion of its full cycle.

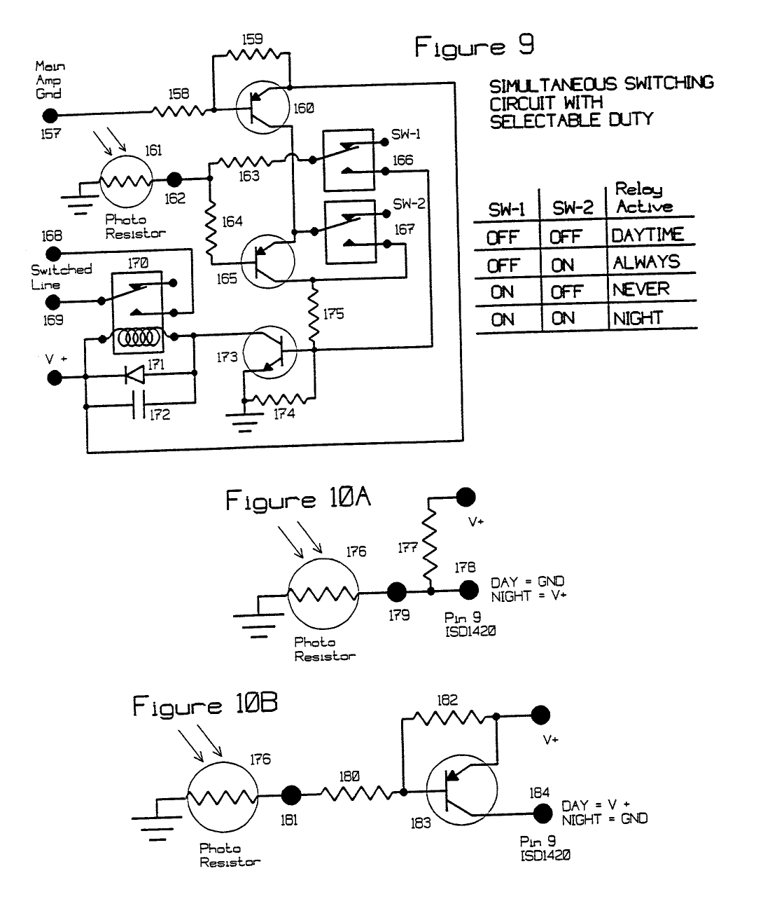

FIG. 9 depicts the optional secondary device switch 11, which will simultaneously turn on a secondary device whenever the sound output is activated. This secondary device could be a visual deterrent device, subsonic sound generating device, or any other electrically functional device. Connection point 157 is connected to point 88 which supplies a ground path whenever the device sounds. The functional secondary device switch is a relay 170 so that lines 168 and 169 connect for the duration that the sound system is active, and then disconnects during the off intervals. A relay is depicted since it is an isolated switching means, allowing electrical devices of other voltages to be controlled. Other means could be adapted and utilized, such as direct use of transistor 173, as might be appropriate for specific secondary devices. Diode 171 and capacitor 172, are used to eliminate undesirable voltage fluctuations associated with the relay's inductive activation coil. The remainder of the circuit is implemented to allow setting how the relay will be actively operating. The table depicts the effect of the settings of two simple switches, 166 (SW-1) and 167 (SW-2). When ground is conducted via connection 157, through current limiting resistor 158, PNP transistor 160 turns on, conducting positive voltage, making a current source available to PNP transistor 165. If photo resistor 161 is conducting from exposure to sufficient light, transistor 165 conducts and turns on the relay driver transistor 173, through current limiting resistor 175. Resistors 159 and 174 are used to prevent the transistors from turning on until sufficient base voltages are present. Photo resistor 161, conducts to ground if in sufficient light, through resistor 163 and switch 166, when on, providing a ground path to cancel activation of relay driver transistor 173. Switch 167 provides a short across transistor 165, so that its activation is of no consequence to transistor 160 activating relay driver transistor 173. This circuit can share the use of photo resistor 75 depicted in basic devices, with point 162 connected to point 79.

FIG. 4 illustrates a functional block diagram of an embodiment of the invention that generates sound via a sound recording audio player and optional recording means. The sounds typically mimic sounds associated with a predator or adversary of a targeted animal, but are not limited to such. The dashed blocks in FIG. 4 indicates an optional feature.

Referring now to FIG. 4, a combination interval/output timer 1 which activates the audio player 13. The output signal from the audio player 13 is amplified by the audio amplifier 5a and optionally by the slave audio amplifier 5b, and transmitted to and emitted from speaker 6a or 6a and 6b. The amplifier power switch 4, turns the audio amplifier 5a or the slave audio amplifier 5b on and off. A setup/run selection switch 7 determines how the combination interval/output timer 1 operates. The output signal from a light sensor 8, is used in conjunction with the setup/run selection switch 7 to determine when the combination interval/output timer 1 operates. The activation of an optional proximity sensor 9 through movement provides an triggering signal directly to the audio player 13 and immediately activates sound output. The output signal from a light sensor 8, can be utilized by the optional “nightshadow” proximity trigger 10, to directly control the function of combination interval/output timer 1. An optional secondary switch 11 serves as a connection point for secondary repelling device. The optional sound recording circuit 14 will allow a user to change or add sounds to audio player 13. The multiple sound management system 15, allows a user to select which stored sound recordings the audio player will output as sound.

In operation of the embodiment shown in FIG. 4, depending on the targeted species, the combination interval/output timer 1 and proximity sensor input 9 is set to allow the sound generator to produce sounds instinctively recognized by animals for a duration of one minute or less, and to provide an interval from one to 60 (sixty) minutes between the sounds instinctively recognized by animals. For example, if the targeted species is deer the interval/output timer 1 is set to allow the sound generator to produce sounds instinctively recognized by animals for a duration of approximately 5 to 10 seconds, and to provide an interval of approximately 6 minutes between the production of the sounds instinctively recognized by animals.

Referring now to FIG. 5, there is shown a circuit diagram which corresponds with the embodiment of the invention as shown by the functional block diagram illustrated in FIG. 4. As stated above, the numbered diagram blocks correspond with the numbered sections of the circuit diagram as enclosed by dashed lines. Because of the similarities between the circuits illustrated in FIG. 3 and FIG. 5. only the different circuit components will be described in detail below.

The audio player 13, which is activated by the combination interval/output timer 1 or proximity sensor input 9, uses actual recorded sounds to provide an important and versatile method of creating instinctive reaction. There are many ways to record and play back sounds, and without limiting the scope of the invention, one specific means will be used as an example. For this embodiment example, the Information Storage Device Co. ISD 1420P integrated circuit 45 is utilized. Integrated circuit 45 can record and hold up to 20 seconds of sound in solid state memory. No energy is needed to retain recorded sounds. The sound memory can be directly addressed at numerous memory locations, effectively allowing a number of different sounds to be stored on and be retrievable from a single integrated circuit. It is energy efficient, holding realistic sound that does not degrade over time or by repeated usage. ISD 1420P is depicted as IC 45 in sections 13 and 14. Section 13 is the play back utilization and section 14 is the utilization as a recording device. Both circuits can be connected simultaneously on the same integrated circuit, but are shown separately for clarity. The recording capability adds cost and is an optionally attached circuit. Many embodiments are supplied with proven effective sounds already recorded and further recording is not required. Pins 1, 2, 3, 4, 5, 6, 9, and 10 are used to address memory locations. Pins 45/6 and 45/9 can be used to access; 0, 5, 10, and 15 second starting address points and are the only ones needed to provide 4 different 5 second sounds. Unused address pins are connected to ground. Positive voltage or ground provide logic to access these addresses and are shown on a chart in FIG. 11B. Pin 45/9 is held to ground by resistor 46 unless an option circuit connected at point 47 were to apply a positive voltage. Pin 45/6 is typically connected to a switch 48, which allows manual selection of two different sounds by connecting to ground or positive voltage. Resistor 49 provides current limiting so that point 50 can be utilized by an option circuit, without respect to how switch 48 is set. Embodiments without switch 48, have a closed circuit to ground, through resistor 49. Pins 12 and 13 are ground supplies. Pins 14 and 15 are low impedance audio outputs to drive a 16 ohm speaker at 1/10 watt. This is not sufficient for this application so pin 45/15 supplies audio signal to a higher output power amplifier and pin 45/14 is used to activate the amplifier. Pins 16 and 28 are positive voltage supplies. Resistors 51, 52 and 53 are pull up devices recommended by the IC manufacturer. Capacitor 54 is recommended for stability. Pin 26 is recommended connected to ground. Pin 45/24 is used to activate sound play back. When ground is applied, even as a short pulse, play back begins at the memory address set by pins 45/6 and 45/9. Play continues until the recorded sound has ended. This “play the complete sound” feature acts as the output timer, depicted as section 2 in other embodiments, so an external timer is not needed for pulse starts from proximity sensor triggering. Other pins are not required for this basic use as a play back sound source.

With the sound recording circuitry 14 connected to the ISD 1420 integrated circuit, the device user can add or change a deterrent sound. Capacitors 105, 106, 109 and resistors 107, 108, and 110 are recommended by the manufacturer to utilize an electret microphone 111 as a sound input means. Resistor 112 and capacitor 113 connected to pin 45/19 and ground, and are as recommended to set the automatic gain for the microphone. Resistor 114 and capacitor 115 are as recommended, and are an external connection between the microphone pre-amplifier and power amplifier. Connection 116 can optionally be used as a line level signal input to record sounds directly off of other electronic sources. Switch 117 is used to activate the recording capability, and is desirable both to conserve power and also to prevent accidental recording activation by actuating switch 125, which would erase existing sounds. When 117 is on, 4 Light Emitting Diodes are used as feedback devices about recording activity. LED 118, through current limiting resistor 119, energizes to indicate recording capability is turned on. LEDs 120 and 121 indicate the logic states of pins 16 and 9 which set the memory address where the recording will begin. The chart shown in FIG. 11B shows the address code. An LED turned on indicates high state (+) and off indicates low state (−). Resistors 122 and 123 limit current. LED 124 indicates that recording is actually taking place, and that function is controlled by actuating momentary switch 125. Resistor 126 limits current. Point 127 is positive supply voltage.

The multi-sound management device 15 allows the user to select a particular sound when more than one is available. ISD 1420 embodiments typically have at least 2 recorded sounds, or blank segments available for recording. Switch 48 is used to choose between these 2 sounds. Switch 135 of section 15A can control a section 3 hiss synthesizer circuit connected to ISD 1420 embodiments for added versatility. While the synthesized hiss could be recorded into the ISD 1420, the recording will lack much of the higher frequencies of the original direct synthesized sound which have proven essential for deterring certain pest animals. To combine circuits: points 128 and 129 are connected together; point 130, shown in FIG. 5, and point 131, shown in FIG. 3, are connected together; points 132, shown in FIG. 5, and point 133, shown in FIG. 3, are connected together. Resistor 134 adjusts signal level and switch 135 selects between position A for section 13, ISD 1420, or position B for the synthesizer 3 as the timed sound. Proximity sensor triggered sound remains the ISD 1420 sound. Switch 135 becomes a closed circuit to position A, if not utilized. Resistor 136 is needed for current limiting if 128 and 129 are connected. Connections to the right of points 131 and 133 are not made.

In another embodiment of this invention, multi-sound management is accomplish with an automatic day/night sound switch. Circuits 10A and 10B are two circuits for accomplishing automatic day/night switching. Circuit 10a depicts a simple means to have one sound during daylight and a different sound at night when using the ISD 1420 sound recorder/player integrated circuit as a sound source. Photo resistor 176 conducts when sufficient light strikes it and has a high resistance during darkness. Resistor 177 holds pin 45/9, as shown in FIG. 5, at a high state during darkness. When photo resistor 176 conducts sufficiently, a low state is produced at pin 45/9. The circuit FIG. 10B depicts a circuit that reverses the output states produced by night or day and is a more desirable circuit for some adaptations. Resistor 46, as shown in FIG. 5, holds pin 45/9 at a low state at night. Referring again to FIG. 10B, when sufficient light strikes photo resistor 176, a ground path is provided to the base of PNP transistor 183 and it conducts a high state to point 184 which is connected to point 47, as shown in FIG. 5, changing pin 9 of ISD 1420 to a high state. Referring again to FIG. 10B, resistor 182 holds the base voltage high and prevents transistor 183 from turning on until a sufficient voltage goes through current limiting resistor 180.

Both circuits, 10a and 10b, can be adapted to share the use of photo resistor 75, as shown in FIG. 5, using the ISD 1420 integrated circuit by connecting terminal 179 or terminal 181 to point 79 of FIG. 5.

Referring now to FIG. 11A, there is shown an additional optional circuit which randomly selects the starting address and therefore the sound played by the ISD 1420 audio recorder/player circuits. A 556 type dual timer integrated circuit 189 is used to produce 2 square wave outputs of different frequencies. Both timers are configured as simple astable outputs at 189/5 and 189/9. Resistor 187 and capacitor 188 set the frequency of T-1 at output 189/5 which would conduct to ISD 1420 pin 6 by connecting point 185 to point 50 (FIG. 5). Resistor 191 and capacitor 190 set the frequency of T-2 at output 189/9 which would conduct to ISD 1420 pin 9 by connecting point 186 to point 47 (FIG. 5). FIG. 11B illustrates a chart showing that when logic states are sampled at regular intervals, the results are a random pair of values. The accompanying chart illustrates the resulting starting address point in the audio storage memory of ISD 1420 that corresponds to the 4 possible pairs of logic states. When the ISD 1420 begins a triggered play back of sound, it locks its mode of operation with respect to the logic states present at pins 6 and 9, so changes in timer output states are ignored until the next triggering. This random selection of 1 of 4 sounds adds an element of variability to the deterrent device that adds greater surprise, can effect a larger variety of animal species, and reduces the possibility of resistance to deterrent effect due to an animal recognizing that the single never varying sound is from a harmless source. Circuit 10b can be combined with circuit 11a to allow random selection of 1 of 2 sounds during the day and 1 of 2 different sounds at night. By either permanent or switching means, the 184 output connection point would replace the 186 output connected to point 47, affecting pin 9 of the ISD 1420 sound recorder/player. Timer T-2 of 189 would not be utilized for this combination.

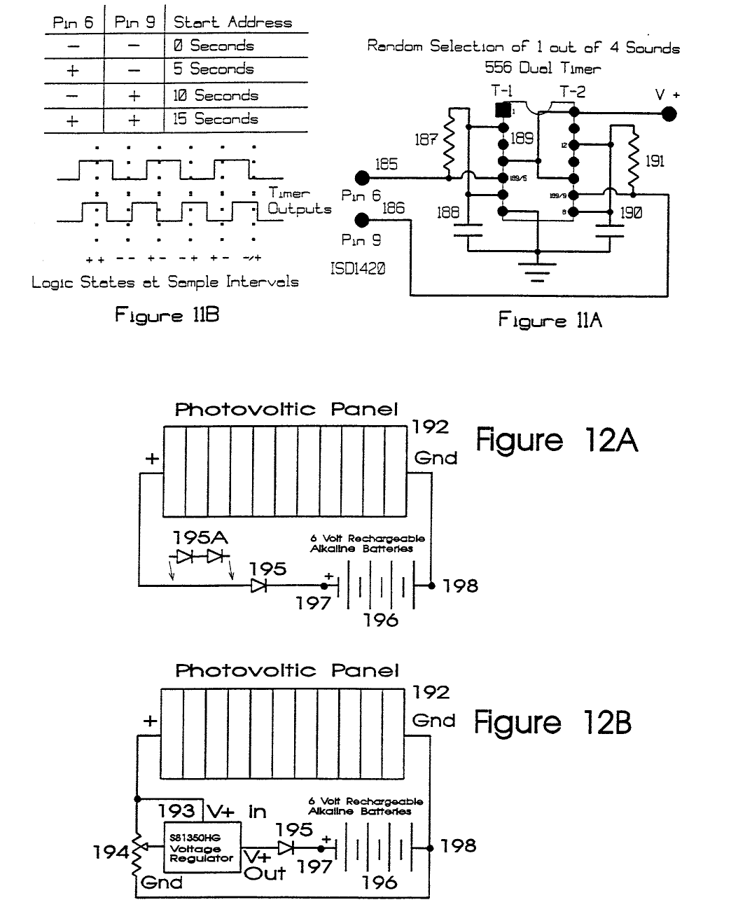

Referring again to FIG. 3 or FIG. 5, there is shown input power terminals in section 12. The device operates on 6 volts DC, with batteries as their power source. Connection 101 is the positive battery terminal and 102 is the battery ground terminal. Diode 103 prevents reverse polarity battery connection from damaging the circuits. Capacitor 104 is a filter to eliminate undesirable voltage fluctuations. Point 137 is positive supply voltage for option circuits, and point 138 is their ground supply. Since the device usage is outdoors, photovoltic panels can optionally be used to maintain a battery charge from sunlight. Circuit illustrated in FIG. 12A shows it is possible to simply use a properly sized photovoltic panel 192 directly connected to device batteries 196, with the addition of at least 1 diode 195 to prevent battery discharge into the panel at low light levels. Additional diodes 195A can be installed in series with diode 195, to reduce peak photovoltic panel output voltage to that which is needed. A regulator circuit as shown in FIG. 12B, can be used to supply charging voltage more accurately and produce a higher rate of charging. Photovoltic panel 192 produces excess voltage in full sunlight, which regulator 193 reduces to the proper voltage required to maintain a 6 volt charge in the device batteries. Diode 195 prevents battery discharge into the panel at low lighting levels, and variable resistor 194 allows adjustment of the regulator's output voltage. Point 197 connects to point 101, and point 198 connects to point 102.

In another embodiment of the invention the proximity switch, as illustrated in FIG. 7, can be configured to be activated by a trip line. A paddle (toggle action) switch and an attached line can be utilized to make a simple yet effective proximity sensing means. The switch is connected to proximity trigger 9 which causes an immediate sounding of the deterrent. The switch also remains in the actuated position, leaving an indication that an animal was present. Referring again to FIG. 1A, there is a cut away side view depicting a switch 209 mounted to the case as a means to activate the device by the pest animal contacting line 216. Actuator position of 219 is the OFF position and position of 210 in the ON, or tripped, position. A line or string 216 is attached to a spring clip 215 and to a fixed stable object 217. When an animal pushes line 216 in any direction it tightens and the actuator moves from position 219 (off) to position 210 (on). If pressure on line 216 is excessive, then spring clip 215 pops free from actuator 210 to prevent damage to the device by a pest. The height 218 that the line is suspended off the ground should match the size of the targeted pest animal. For deer, distance 218 would be 2½ to 3 feet. This would allow smaller animals to pass underneath without activating the device.

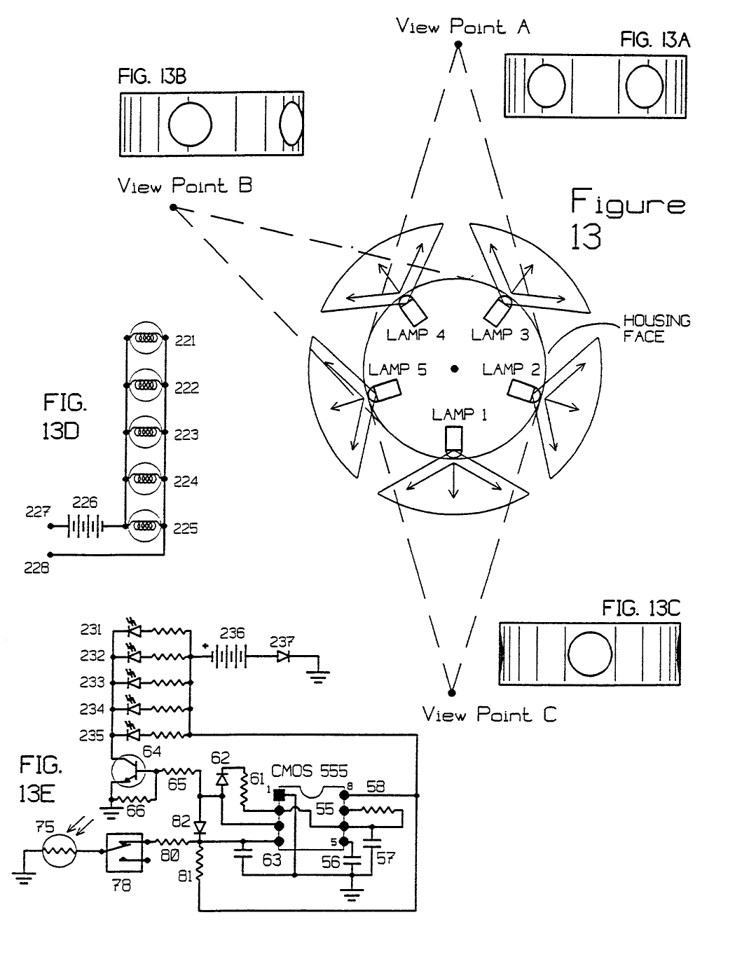

Finally, there is shown in FIGS. 13, 13A-13E a visual deterrent means that creates an illusion of animal eyes at night, that activate on a timed basis, with the timing cycles the same as defined for the audio deterrent. In one preferred embodiment, it is connected with the audio deterrent and lamps turn on at the same time that the audio deterrents produce a predator sound output. It may also remain on somewhat longer than the sound, to give the affected animal time to visually locate and identify its presence. This adds an additional element of realism to the audio illusion of the presence of a predator. Lamps 1-5 are arrayed radially around a central point on a single plane that will be horizontal when in use. The lamps are spaced at 72 degree separations around the central point. The angle of the their projected beam is wider than their spacing. FIG. 13 illustrates 120 degree beam spread, indicated by the area enclosing three arrows. The arrow indicate the direction of the beam projection. The circle near the front of the lamps represents the housing wall outer face and the projected light would be visible from the intersection of the beam on this surface and also forward from that surface as indicated by the angular beams outlines. From view point A, lamps 3 and 4 are equally visible, appearing as two eyes which constitutes an instinctively recognized visual stimulus for discouraging and/or repelling animals. FIG. 13A approximates what is seen from view point A, with circular objects representing the illuminated eyes and the rectangle being a section of the housing face. From view point B, lamps 4 and 5 are visible, with lamp 5 beginning to be off angle enough to start losing visibility. FIG. 13B approximates what is seen from view point B. From view point C, only lamp 1 is clearly visible, but moving just slightly left or right would bring lamps 5 or 2 into view. FIG. 13C approximates what is shown from view point C. During actual use the view points are much further away and the single lamp situation of view point C would be very minimal and two lamps will typically be visible from any view point. Three lamps are never visible from a single viewpoint. The two lamps simulate reflected light from two eyes when lamp intensity is adjusted to a realistic level. If the animal viewing the visual deterrent moves away, to a side or around it, one lamp comes into view as another is lost from view. This creates the illusion that the eyes are turning and following their movement, which suggest animate motion to the viewer. FIG. 13D illustrates a basic circuit to energize the light output. Lamps 221, 222, 223, 224 and 225 are powered by battery 226 when points 227 and 228 are connected together. In other embodiments, the display can be controlled by the circuit shown in FIG. 9. Point 227 would connect to point 168, and point 228 would connect to point 169. When the circuit of FIG. 9 is connected to the circuit of either FIG. 3 or FIG. 5, and SW-1 and SW-2 are ON, the lamps will illuminate at night concurrently whenever sound output occurs.

FIG. 13E illustrates an independent device circuitry that uses the same timing circuit as section 1 of FIGS. 3 and 5, to provide the presentation means for LED type lamps 231, 232, 233, 234, 235. Battery 236 provides power and diode 237 protects the circuit against accidental reverse battery polarity. Switch 78 allows disconnection of photoresistor 75 so that function can be tested in daylight. When switch 78 is closed, photoresistor 75 prevents function in daylight to conserve battery drain. Detailed circuit explanation of timer section 1 and photoresistor 75 (section 8) is covered by text for FIG. 3. The resulting independent device uses the same output and interval parameters as the sound output embodiments, but substitutes the instinctively recognized visual means for the instinctively recognized sound means.

The sounds noted above may be supported by other illusions to reinforce fleeing, e.g., the smell of blood and/or raw flesh.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. An apparatus for use by an operator for discouraging and/or repelling the undesired encroachment of a animal upon property, said apparatus comprising:
a sound generator providing for one or more sounds instinctively recognized by the animal; and
a timer for selectively activating the sound generator at repeated periods of time and/or for a duration of time as defined by operator input.

2. An apparatus according to claim 1, wherein said sound generator provides means for the operator to input one or more audible sounds instinctively recognized by the animal.

3. An apparatus according to claim 1, wherein said sounds instinctively recognized by the animal comprise sounds that produce an innate fear in said animal or wherein said sounds discourage the presence or return of said animal.

4. An apparatus according to claim 1, wherein said sounds instinctively recognized by the animal mimic sounds corresponding to a predator or menace of said animal and/or mimic sounds which attracts a predator or menace of said animal and/or mimic sounds corresponding to a hiss produced by a member of the cat or reptile species and/or mimic sounds corresponding to a scream or growl of a feline or member of the cat family and/or sounds similar to one made by an animal to signal threat and/or danger.

5. An apparatus according to claim 1 further comprising a visual generator providing for a visual stimulus to the animal and wherein the timer selectively activates the sound generator and/or the visual generator at repeated periods of time and/or for a duration of time as defined by operator input.

6. The apparatus according to claim 1 further comprising:
a terminal for receiving input from a proximity sensing means sensing creatures and overriding said timer to activate said sound generator when a creature is sensed.

7. An apparatus according to claim 6, wherein said sound generator provides means for the operator to input one or more audible sounds instinctively recognized by the animal.

8. An apparatus according to claim 6, wherein said sounds instinctively recognized by the animal comprise sounds that produce an innate fear in said animal or wherein said sounds discourage the presence or return of said animal.

9. An apparatus according to claim 6, wherein said sounds instinctively recognized by the animal mimic sounds corresponding to a predator or menace of said animal and/or mimic sounds which attracts a predator or menace of said animal and/or mimic sounds corresponding to a hiss produced by a member of the cat or reptile species and/or mimic sounds corresponding to a scream or growl of a feline or member of the cat family and/or sounds similar to one made by an animal to signal threat and/or danger.

10. An apparatus according to claim 6 further comprising a visual generator providing for a visual stimulus to the animal and wherein the timer selectively activates the sound generator and or the visual generator at repeated periods of time and/or for a duration of time as defined by operator input.

11. An apparatus according to claim 5, wherein said sound generator provides means for the operator to input one or more audible sounds instinctively recognized by the animal.

12. A apparatus according to claim 5, wherein said sounds instinctively recognized by the animal comprise sounds that produce an innate fear in said animal or wherein said sounds discourage the presence or return of said animal.

13. An apparatus according to claim 5, wherein said sounds instinctively recognized by the animal mimic sounds corresponding to a predator or menace of said animal and/or mimic sounds which attracts a predator or menace of said animal and/or mimic sounds corresponding to a hiss produced by a member of the cat or reptile species and/or mimic sounds corresponding to a scream or growl of a feline or member of the cat family and/or sounds similar to one made by an animal to signal threat and/or danger.

14. An apparatus for use by an operator for discouraging and/or repelling the undesired encroachment of a animal upon property, said apparatus comprising:
a sound generator providing for one or more sounds instinctively recognized by the animal; and
a terminal connection point for receiving input from a proximity sensing means sensing creatures and overriding said timer to activate said sound generator when a creature is sensed.

15. An apparatus according to claim 14, wherein said sound generator provides means for the operator to input one or more audible sounds instinctively recognized by the animal.

16. A apparatus according to claim 14, wherein said sounds instinctively recognized by the animal comprise sounds that produce an innate fear in said animal or wherein said sounds discourage the presence or return of said animal.

17. An apparatus according to claim 14, wherein said sounds instinctively recognized by the animal mimic sounds corresponding to a predator or menace of said animal and/or mimic sounds which attracts a predator or menace of said animal and/or mimic sounds corresponding to a hiss produced by a member of the cat or reptile species and/or mimic sounds corresponding to a scream or growl of a feline or member of the cat family and/or sounds similar to one made by an animal to signal threat and/or danger.

18. An apparatus for use by an operator for discouraging and/or repelling the undesired encroachment of a animal upon property, said apparatus comprising:
a visual generator providing a visual stimulus instinctively recognized by the animal; and
a timer for selectively activating the visual generator at repeated periods of time and/or for a duration of time as defined by operator input.

19. The apparatus according to claim 18 further comprising a terminal connection point for receiving input to activate said visual generator.
